(19) United States
(12) Patent Application Publication
(10) Pub. No.: US 2018/0035653 A1
(43) Pub. Date: Feb. 8, 2018

(54) Spring-Loaded Crabbing Device

(71) Applicant: Luke Lawrence, Rockwall, TX (US)

(72) Inventor: Luke Lawrence, Rockwall, TX (US)

(21) Appl. No.: 15/614,803

(22) Filed: Jun. 6, 2017

Related U.S. Application Data
(60) Provisional application No. 62/372,041, filed on Aug. 8, 2016.

(51) Int. Cl. A01K 69/08

(52) U.S. Cl. CPC A01K 69/08; A01K 69/06

(57) ABSTRACT

A spring-loaded crabbing device for catching crabs. The spring-loaded crabbing device includes an elongated shaft utilized as a handle, wherein two gripping jaws are connected to an end thereon. The gripping jaws being hingedly connected via a spring biased toward a closed position. The closed position is formed when the outer perimeters of the gripping jaws align with each other, while an open position is formed when the perimeter edges opposite the hinged connection are separated from each other. The gripping jaws are held in an open configuration via a triggering mechanism having two rigid members that are each pivotally attached to a separate gripping jaw and movable radially relative to the gripping jaws. The rigid members of the triggering mechanism interact in a way which allows the gripping jaws to move into the closed position when activated.

### CROSS REFERENCE TO RELATED APPLICATIONS

This application claims the benefit of U.S. Provisional Application No. 62/372,041 filed on Aug. 8, 2016. The above identified patent application is herein incorporated by reference in its entirety to provide continuity of disclosure.

### BACKGROUND OF THE INVENTION

The present invention relates to a spring-loaded crabbing device. More specifically, the present invention provides an elongated shaft pivotally connected to a pair of spring loaded gripping jaws configured to catch animals, such as crabs.

Crab gigging is a fun and exciting leisure activity and hobby. Traditional crab gigging, however, has the problem of fatally harming the crab. As a result, gigged crabs die and start to spoil rapidly, preventing them from being placed safely back in the water or requiring the crab to be cleaned immediately after being caught for safe consumption. Alternatively, if captured unharmed, crabs can be kept alive until cleaning time is convenient.

Another problem is that different crab species have varying regulations on size with penalties that can attach for violations of gigging undersized crabs. Certain crabs cannot be gigged and only allow for the claws to be harvested with the crab being returned back to the water. There is too much of a risk for many people that a visual assessment will be inaccurate and a citation will result when gigging. In order to address these concerns, the present invention provides a crabbing device having spring-loaded jaws for catching a crab without causing harm to the animal.

### SUMMARY OF THE INVENTION

In view of the foregoing disadvantages inherent in the known types of crabbing devices now present in the prior art, the present invention provides a spring-loaded crabbing device wherein the same can be utilized for providing convenience for the user when attempting to safely capture crabs without harming them.

It is therefore an object of the present invention to provide a new and spring-loaded device that has all of the advantages of the prior art and none of the disadvantages.

It is another object of the present invention is to provide a spring-loaded crabbing device comprising an elongated shaft having two gripping jaws hingedly connected to each other and attached to an end thereon, wherein the gripping jaws define an interior volume when aligned in a closed position.

It is another object of the present invention is to provide a spring-loaded crabbing device that is extendable telescopically.

Yet another object of the present invention is to provide a spring-loaded crabbing device wherein the gripping jaw structures are made of rigid lattice pattern to allow for water flow.

Another object of the present invention is to provide a spring-loaded crabbing device wherein the gripping jaws have outer perimeters substantially rectangular in shape with rounded corners.

Another object of the present invention is to provide a spring-loaded crabbing device wherein lighting strips are attached to the outer perimeter, illuminating the edges of the device.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the spring-loaded crabbing device in a closed position.

FIG. 2 shows a perspective view of an embodiment of the spring-loaded crabbing device in an opened position as well as an inset close-up view of an end of the spring-loaded crabbing device in an open position.

FIG. 3 shows front view of the two rigid members comprising the triggering mechanism.

FIG. 4 shows a perspective view of an embodiment of the spring-loaded crabbing device in use.

FIG. 5 shows a side view of an embodiment of the spring-loaded crabbing device in a closed position.

FIG. 6 shows a perspective view of an alternate embodiment of the spring-loaded crabbing device in an open position.

FIG. 7 shows a perspective view of an alternate embodiment of the spring-loaded crabbing device in use.

### DETAILED DESCRIPTION OF THE INVENTION

Reference is made herein to the attached drawings. Like reference numerals are used throughout the drawings to depict like or similar elements of the spring-loaded crabbing device. For the purposes of presenting a brief and clear description of the present invention, the preferred embodiment will be discussed as used for catching crabs in water. The figures are intended for representative purposes only and should not be considered to be limiting in any respect.

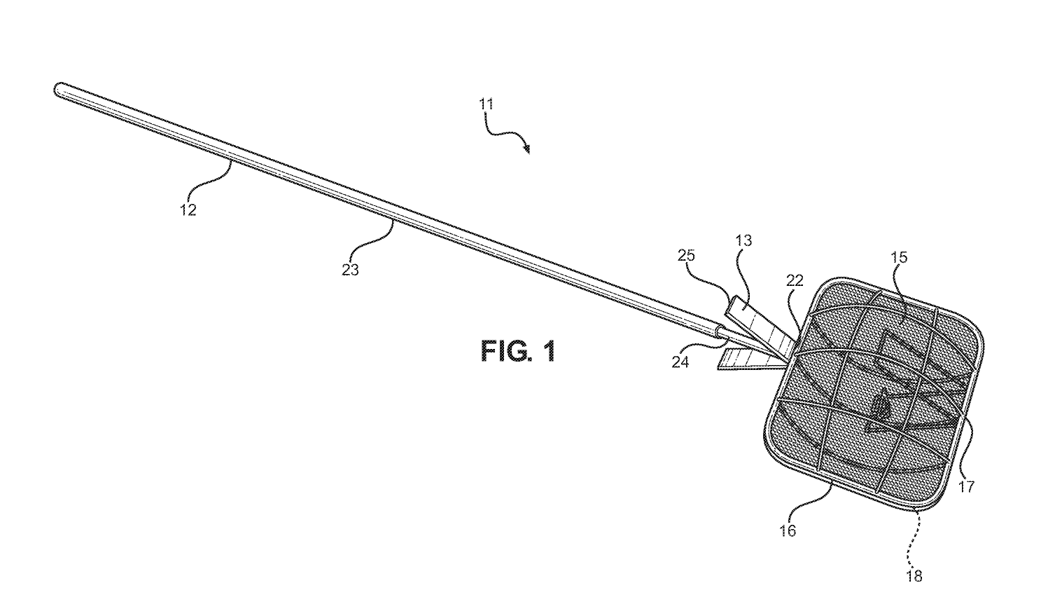

Referring now to FIG. 1, there is shown a perspective view of an embodiment of the spring-loaded crabbing device in a closed position. The spring-loaded crabbing device 11 comprises an elongated shaft 12 whereon a first gripping jaw 17 and a second gripping jaw 18 are attached to an end thereon. The elongated shaft 12 comprises a first rod 23 and a second rod 24 telescopically connected to one another. In alternate embodiments, the elongated shaft 12 is composed of a single rod. In other embodiments, the elongated shaft 12 is composed of two or more rods telescopically connected to one another.

The first gripping jaw 17 and the second gripping jaw 18 are each defined by a support structure 15 having an outer perimeter 16 and interior volume. In the illustrated embodiment, the support structure 15 comprises a lattice design to allow water to flow therethrough while providing rigidity to the jaws 17, 18. The support structures 15 each comprise a sidewall extending from the outer perimeter 16 of each jaw 17, 18 and terminate at a central portion forming the base of each jaw 17, 18, wherein the base is opposite the outer perimeter 16. The gripping jaws 17, 18 are movable between a closed and an open position for securing and receiving a crab therein, respectively. In the closed position, the outer perimeters 16 of each gripping jaw 17, 18 are aligned and rest flush against each other defining an interior volume therebetween. In the illustrated embodiment, the outer perimeters 16 comprise preferably a rectangular shape with rounded corners. However, in other embodiments, the outer perimeter 16 can be any suitable shape.

Handles 13 extend outward from opposite sides of the spring pivot connection 22 and are attached to the gripping jaws 17, 18 adjacent to the point where they connect to the elongated shaft 12. In the illustrated embodiment, the handles 13 comprise planer coverings that encompass the protruding ends of the spring pivot connection 22. When the distal ends 25 of the handles 13 are squeezed toward each other, the force overcomes the bias of the spring pivot connection 22 towards the closed position, such that the handles 13 allow the jaws 17, 18 to move to the open position.

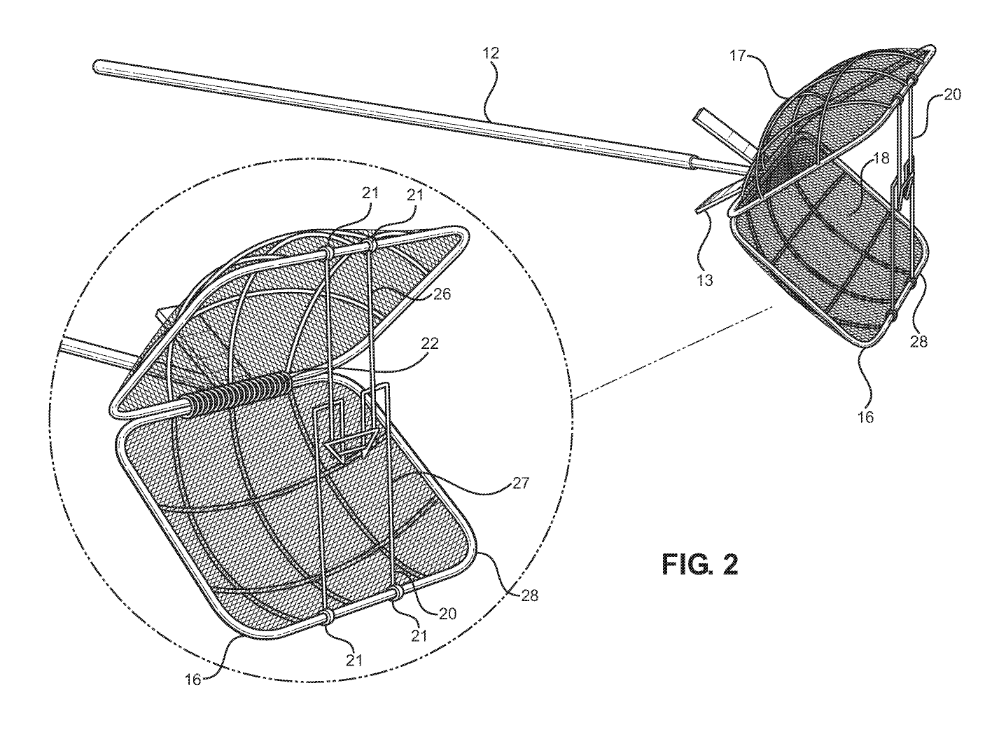

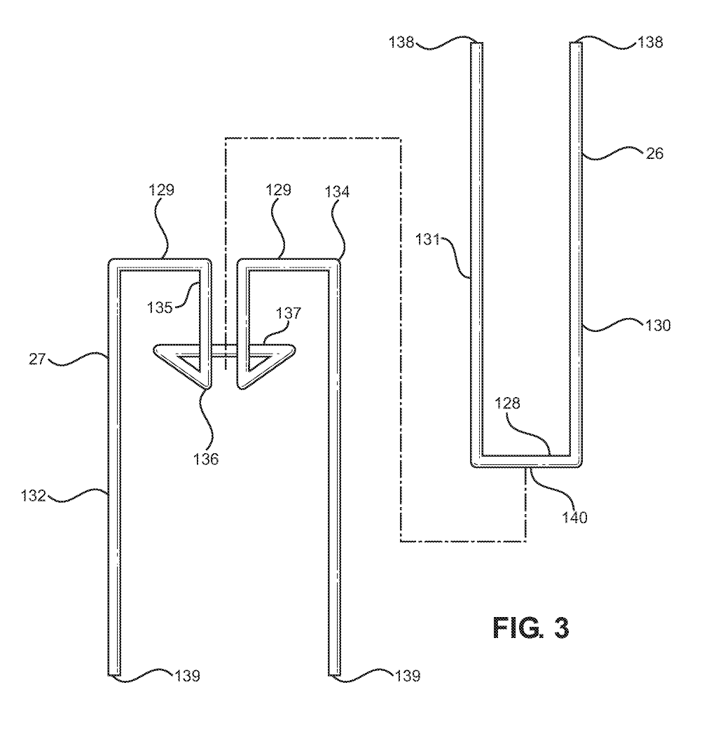

Referring now to FIGS. 2 and 3, there is shown a perspective view of an embodiment of the spring-loaded crabbing device in an opened position as well as an inset close-up view of an end of the spring-loaded crabbing device in an open position and a front view of the two rigid members comprising the triggering mechanism, respectively. The first gripping jaw 17 and the second gripping jaw 18 are attached via a spring pivot connection 22 along one edge of the outer perimeters 16 and connected to the elongated shaft 12. The handles 13 operate to control the gripping jaws 17 and 18 which is biased toward the closed position by the spring pivot connection 22. An opened position is defined when the outer perimeters 16 of the first gripping jaw 17 and the second gripping jaw 18 are separated from each other along the edges opposite the springe pivot connection 22.

A triggering mechanism 20 is connected to both the first gripping jaw 17 and the second gripping jaw 18 and keeps jaws 17, 18 supported in the open position. In the illustrated embodiment, the triggering mechanism 20 is composed of two rigid members 26, 27 that are each attached to one of the gripping jaws 17, 18 and are removably affixable to each other. The proximal ends 138, 139 of each rigid member 26, 27 of the triggering mechanism 20 are attached to the support structure 15, along the perimeter 16 of a respective gripping jaw 17, 18 opposite the spring pivot connection 22. Each rigid member 26, 27 of the triggering mechanism 20 is pivotally attached to the support structure 15 so as to allow for radial movement toward the interior volume or spring pivot connection 22.

The gripping jaws 16, 17 are supported in an open configuration by the triggering mechanism 20 when the two rigid members 26, 27 are removably affixed to one another at the distal ends thereof. The hinged connections 21 of the proximal ends 138, 139 of the rigid members 26, 27 allows for the triggering mechanism 20 to collapse in an inward direction toward the interior volume. In the illustrated embodiment, each of the rigid members 26, 27 of the triggering mechanism 20 comprise a continuous bar designed to interlock with the other. The first rigid member 26 comprises two sides 130, 131 running in parallel from the hinged connections 21 and joined by a first crossbar 128 at the distal end 140 thereof, forming a U-shape.

The second rigid member 27 comprises two sides 132, 133 running in parallel from the hinged connections 21 forming a first bend 134 that extends orthogonally inward toward one another at the distal end 129 thereof. The distal end 129 of the second rigid member 27 extends perpendicularly to the two sides 132, 133 before forming a second orthogonally downward bend 135 toward the outer perimeter 16 Finally, the second rigid member 27 ends with the two sides each bending outward at an acute angle 136 towards the distal end 129 of the bar and away from the hinged connections 21 before joining with a second crossbar 137, wherein the second crossbar 137 of the second rigid member 27 is perpendicular to the two sides 132, 133.

The second rigid member 27 forms a notch between the crossbar 137, the acute angle bend 136, and the distal end 129 of the second rigid member 27 for the first rigid member 26 to be received. The crossbar 137 and distal end 129 of the second rigid member 27 do not allow the triggering mechanism 20 to release outward but does allow the rigid members 26, 27 to fully collapse toward the interior volume so that the gripping jaws 17, 18 can align in a closed position. The triggering mechanism 20 is calibrated to a sensitivity that allows for the rigid members 26, 27 to collapse upon contact with a solid object, such as a crab, and not when positioned through the force of water resistance in use. In the illustrated embodiment, the rods of the first and second rigid members 26, 27 are composed of a rigid metal. In alternate embodiments, any suitable rigid material is used to form the rods.

In the illustrated embodiment, the device comprises Illumination strips 28 disposed on the outer perimeter 16 of each gripping jaw 17, 18 so as to provide for increased visibility when crabbing at night or in dark waters. The illumination strips 28 in one embodiment comprises tubing wherein a light source is disposed therein, the light source being an LED. In some embodiments, an internal power source is positioned within the tubing. In other embodiments, the illumination strips 28 are replaceable once the power source is depleted. In alternate embodiments, the illumination strips 28 can be composed of photoluminescent material.

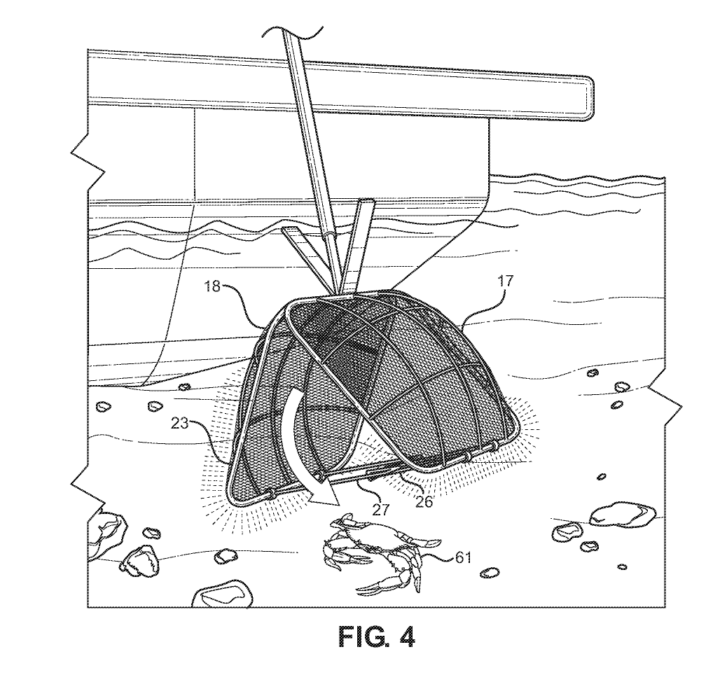

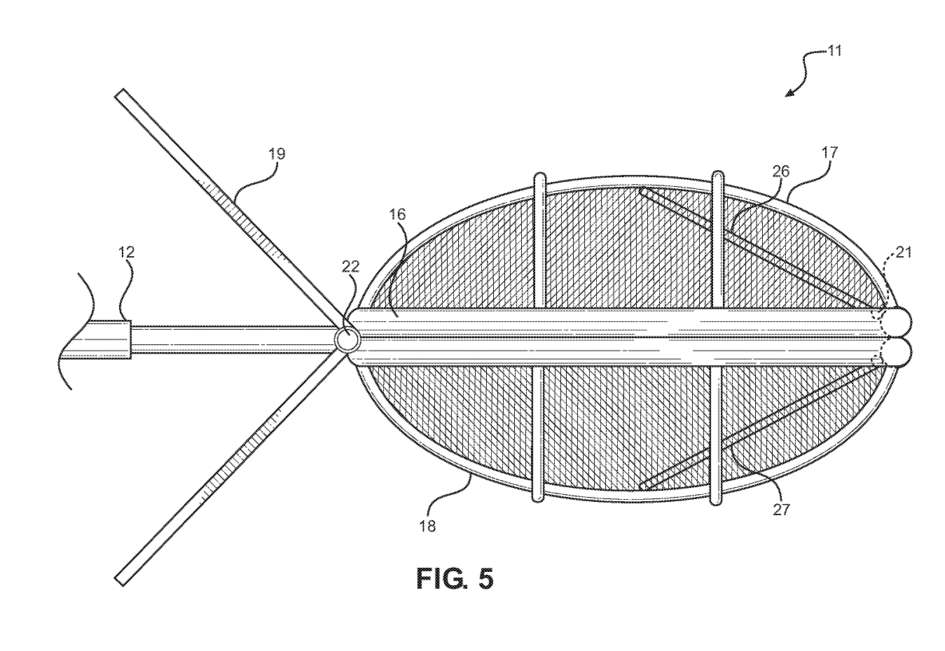

Referring now to FIGS. 4 and 5, there is shown a perspective view of an embodiment of the spring-loaded crabbing device in use and a side view of an embodiment of the spring-loaded crabbing device in a closed position, respectively. When in an opened position, contact with the triggering mechanism 20 will cause the two rigid members 26, 27 to collapse pivotally inward. When the triggering mechanism 20 collapses, the spring pivot connection 22 forces the gripping jaws 17 and 18 to align in a closed position with the outer perimeters 16 resting flush against each other. The rigid lattice design support structure 15 of the first gripping jaw 17 and second gripping jaw 18 define an interior volume when in a closed position for securing the crab 61 therein.

In operation, the gripping jaws 17, 18 of the spring-loaded crabbing device are opened with the handles by moving the distal end of the handles toward one another. The gripping jaws 17, 18 remain in an open position by setting the triggering mechanism 20 in place between the two gripping jaws such that the two rigid members 26, 27 are linearly aligned with each other. When the triggering mechanism 20 is set, the two rigid members 26, 27 are held together in tension by the spring pivot connection 22. When the triggering mechanism 20 is contacted, the rigid members 26, 27 collapse inward into the interior volume. The crabbing device is used in water or on land where the triggering mechanism 20 comes into contact with a crab 61 or other animal thereby releasing the triggering mechanism and allowing the gripping jaws 17, 18 to shut in a closed position around the crab 61 or animal. The crab 61 or animal can then be retrieved from the defined volume inside the closed gripping jaws 17, 18 via the handles 13.

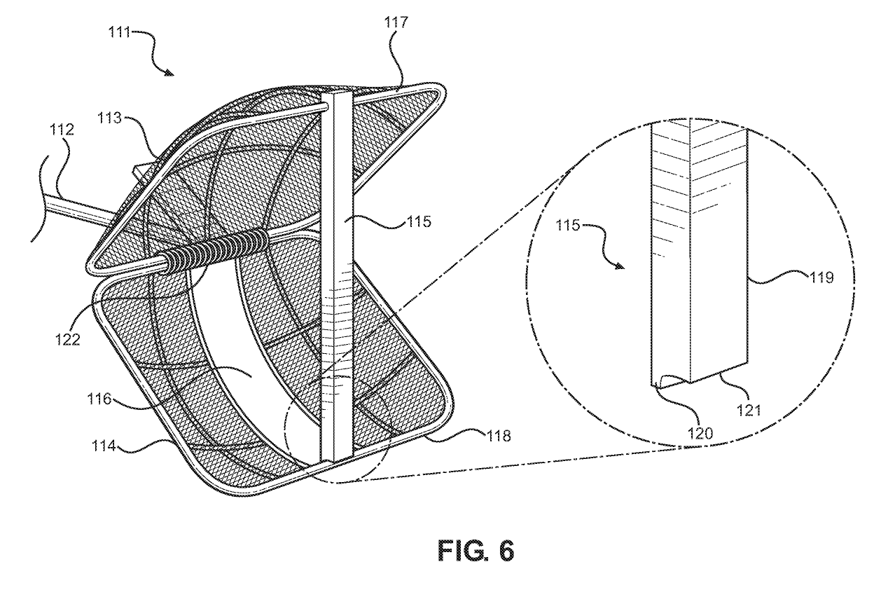

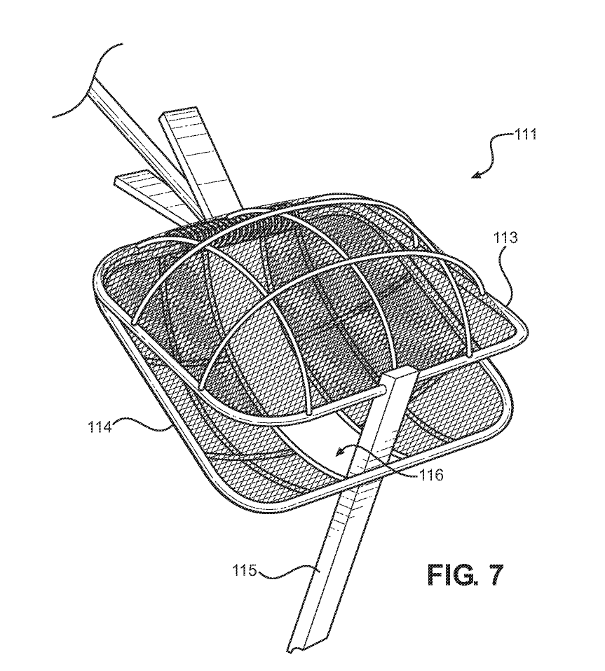

Referring now to FIGS. 6 and 7, there is shown a perspective view of an alternate embodiment of the spring-loaded crabbing device in an opened position and in use, respectively. In an alternate embodiment, the triggering mechanism 115 comprises a single rod 119 axially connected to a first gripping jaw 117 while having a notched configuration 120 on the distal end of the rod 119. The notched configuration 120 is formed through an L-shaped cutout 121 on the distal end of the single rod 119 on the side facing away from the interior volume when in an opened position. The L-shaped cutout 121 of the notched configuration 120 allows the rod 119 to latch onto the upper and interior edge of the outer perimeter 114 of the second gripping jaw 118 to maintain an open position.

In the alternate embodiment, the second gripping jaw 118 comprises a channel 116 larger than the width of the triggering mechanism 115 extending from the spring pivot connection 122 to the outer perimeter 114 on the opposite side of the second gripping jaw 118. The channel 116 allows for the single rod 119 triggering mechanism 115 to pass through after being contacted with enough force to dislodge the notched configuration 120 from the outer perimeter 114. After being contacted, the triggering mechanism 115 releases inward and passes through the channel 116 allowing for the gripping jaws 117 and 118 to shut in a closed position wherein the outer perimeters 114 rest flush against one another defining an interior volume.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A spring-loaded crabbing device, comprising:
an elongated shaft;
a first gripping jaw and a second gripping jaw hingedly connected to each other and the elongated shaft;
wherein the first gripping jaw and the second gripping jaw define a closed position when the outer perimeter of the first gripping jaw aligns flush against the outer perimeter of the second gripping jaw;
a triggering mechanism disposed between the first gripping jaw and the second gripping jaw and configured to keep the gripping jaws separated;
wherein the triggering mechanism comprises a first rigid member connected to the first gripping jaw and a second rigid member connected to the second gripping jaw, wherein a distal end of the first gripping jaw is removably affixed to a distal end of the second gripping jaw when in an opened position, such that the outer perimeters of the gripping jaws are separated from one another.

2) The spring-loaded crabbing device of claim 1, wherein the elongated shaft is extendable telescopically.

3) The spring-loaded crabbing device of claim 1, wherein a spring hingedly connects the first gripping jaw to the second gripping jaw and the elongated shaft, the spring being biased toward the closed position.

4) The spring-loaded crabbing device of claim 3, further comprising a pair of handles extending from opposing sides of the spring, wherein the handles control the positions of the first and second gripping jaws.

5) The spring-loaded crabbing device of claim 1, wherein the gripping jaws have a rectangular perimeter.

6) The spring-loaded crabbing device of claim 1, wherein the first and second gripping jaws have rounded corners along their perimeter.

7) The spring-loaded crabbing device of claim 1, wherein sidewalls extend from the outer perimeter of each first and second gripping jaw and terminate at a central portion forming a base of each first and second gripping jaw.

8) The spring-loaded crabbing device of claim 1, wherein each of the first and second gripping jaws comprise a rigid lattice design to facilitate water flow through the interior volume.

9) The spring-loaded crabbing device of claim 1, wherein a lighting strip is disposed on the outer perimeter of each of the first and second gripping jaws.

10) The spring-loaded crabbing device of claim 9, wherein the lighting strips are self-contained and water resistant.

11) The spring-loaded crabbing device of claim 9, wherein the lighting strips have an internal power source that is replaceable when depleted.

12) A spring-loaded crabbing device, comprising:
an elongated shaft;
a first gripping jaw and a second gripping jaw hingedly connected to each other and the elongated shaft;
wherein the first gripping jaw and the second gripping jaw define a closed position when the outer perimeter of the first gripping jaw aligns flush against the outer perimeter of the second gripping jaw;
a channel disposed on the second gripping jaw, wherein the channel extends from a first end to a second end thereof;
a triggering mechanism disposed between the first gripping jaw and the second gripping jaw and configured to keep the gripping jaws separated;
wherein the triggering mechanism comprises a rod having a proximal end pivotally affixed to the first gripping jaw and a distal end removably affixed to the second gripping jaw;
wherein the distal end of the rod is configured to pass through the channel.

13) The spring-loaded crabbing device of claim 12, wherein the distal end of the triggering mechanism comprises a notched configuration such that the rod rests on the upper edge of the perimeter of the second gripping jaw.
